(19) United States
(12) Patent Application Publication
(10) Pub. No.: US 2015/0078815 A1
(43) Pub. Date: Mar. 19, 2015

(54) EXTENDABLE JACK TOOL

(71) Applicant: Ford Global Technologies, LLC, Dearborn, MI (US)

(72) Inventors: Wendy Ge, Nanjing (CN); Brenna Liu, Nanjing (CN); Jack Xu, Nanjing (CN)

(73) Assignee: Ford Global Technologies, LLC, Dearborn, MI (US)

(21) Appl. No.: 14/193,164

(22) Filed: Feb. 28, 2014

(30) Foreign Application Priority Data
Sep. 16, 2013 (CN) 201320574078.5

(51) Int. Cl. F16B 21/08; B66F 13/00

(52) U.S. Cl. CPC F16B 21/08; B66F 13/00
USPC 403/330; 403/376

(57) ABSTRACT

According to one or more embodiments, a jack tool includes an inserting end, the inserting end including a connection insert positioned within the inserting end, the connection insert including first and second protrusions linked to be movable together. The inserting end may include a pair of spaced apart first apertures to receive the first and second protrusions, respectively.

### RELATED APPLICATION

This application claims the benefit of Chinese Utility Model Patent Application No.: CN201320574078.5, filed Sep. 16, 2013, the entire contents thereof being incorporated herein by reference.

### TECHNICAL FIELD

The disclosed inventive concept relates generally to extendable jack tools.

### BACKGROUND

Conventionally jack is a light-weight lifting equipment employing the use of steel for operation wherein lifting is realized via a top support or a bottom holder. There are two types of jack, namely mechanical and hydraulic. Because there is a limit on how long the arm of a jack can practically be, a jack tool is often used to extend the operating length of the arm. In certain existing technologies, the jack tool is configured to include a protrusion on one member of the jack tool and a recess on another member. In such configurations, relative position of the members of the jack tool is hard to identify; this in turn often makes engagement and disengagement of the members of a jack tool unnecessarily cumbersome and time-consuming.

By way of example, U.S. Pat. No. 5,237,890 discloses an extension arm for a vehicle jack. A fastening clip is positioned between and connects two adjacent extension arms. The fastening clip includes resilient leg, the extension and return thereof resulting the fastening of the fastening clip between the extension arms.

By way of another example, Chinese Utility Model Application Publication No.: 202864807U discloses a two-section jack arm. Connection and disconnection between the two sections of the jack arm is realized via a resilient clip and pin positioned in the jack arm.

According to certain of these existing technologies, connection and disconnection of a jack arm is realized through the use of a fastening clip or a resilient clip, wherein relative position between members of the jack arm is not easily distinguishable when one member is being inserted to another as needed. Therefore the process may be cumbersome and time-consuming.

It would thus be advantageous if a jack tool and/or a jack assembly may be produced without these identified problems, particularly problems in relation to ease of operation.

### SUMMARY

According to one or more embodiments, a jack tool includes an inserting end, the inserting end including a connection insert positioned within the inserting end, the connection insert including first and second protrusions linked to be movable together.

The inserting end may include a pair of spaced apart first apertures to receive the first and second protrusions, respectively.

The connection insert may include a resilient body, the first and second protrusions being positioned upon the resilient body. The resilient body may be a U-shaped resilient piece. The U-shaped resilient piece may be positioned within the inserting end with an open end facing outwardly.

The resilient body may be a V-shaped resilient piece positioned within the inserting end with an open end facing outwardly.

The first and second protrusions may extend outwardly from a wall of the resilient body.

The first protrusion may have a longitudinal length greater than a longitudinal length of the second protrusion.

According to one or more other embodiments, a jack tool includes a first shaft with an inserting end, and a second shaft with a receiving end, wherein the inserting end includes a connection insert, the connection insert including a resilient body with first and second protrusions positioned on the resilient body.

According to one or more other embodiments, a jack tool includes a first shaft including an inserting end with two spaced part first apertures, a second shaft including a receiving end with a second aperture, and a connection insert including first and second protrusions, the first protrusion receivable through one of the first apertures, the second protrusion receivable through both the second aperture and the other of the first apertures. The connection insert may further include a resilient body to support the first and second protrusions. The connection insert may be detachable from the inserting end of the first shaft.

The above advantages and other advantages and features will be readily apparent from the following detailed description of embodiments when taken in connection with the accompanying drawings.

### BRIEF DESCRIPTION OF THE DRAWINGS

For a more complete understanding of embodiments of this invention, reference should now be made to the embodiments illustrated in greater detail in the accompanying drawings and described below by way of examples wherein:

FIG. 1 illustratively depicts a partial perspective view of a jack tool according to one or more embodiments;

FIG. 2 illustratively depicts a partial, enlarged perspective view of the jack tool referenced in FIG. 1;

FIG. 3 illustratively depicts an enlarged perspective view of an inserting end of the jack tool referenced in FIG. 1;

FIG. 4 illustratively depicts an enlarged perspective view of an inserting end of the jack tool referenced in FIG. 1;

FIG. 5 illustratively depicts a partial perspective view of a second shaft of the jack tool referenced in FIG. 1; and

FIG. 6 illustratively depicts a partial perspective view of the jack tool referenced in FIG. 1, wherein first and second shafts of the jack tool are shown connected.

### DETAILED DESCRIPTION OF ONE OR MORE EMBODIMENTS

As referenced in the FIG.s, the same reference numerals are used to refer to the same components. In the following description, various operating parameters and components are described for different constructed embodiments. These specific parameters and components are included as examples and are not meant to be limiting.

The disclosed inventive concept is believed to have overcome one or more of the problems associated with certain existing jack tools.

The present invention in one or more embodiments is advantageous in at least providing one or more of the benefits stated herein in relation to a jack tool. In one aspect, the jack tool includes a shaft with an inserting end, which in turn includes a connection insert, the connection insert including a first protrusion and a second protrusion, wherein the second protrusion functions as a connector such that when the shaft is to be connected to a matching shaft as needed, all that is needed to do may be to position the second protrusion through an aperture of the matching shaft to effect the connection between the shaft and the matching shaft. In other words, engagement and disengagement between shafts of the jack tool may be realized via controlling the first protrusion and the second protrusion. Therefore, reasonably greater ease of operation is afforded with the jack tool described herein.

In certain instances, first and second protrusions of the shaft may be provided on a resilient body. A user may press the first protrusion, and with the pressing, the distance traveled by the first protrusion is shorter than the distance traveled by the second protrusion that may move along with the first protrusion. In other words, pressing the first protrusion which causes the first protrusion to travel for a certain distance can effectuate the second protrusion to be disengaged from the aperture of the matching shaft. Accordingly disengagement between the shaft and the matching shaft can be made relatively more convenient and labor-efficient.

In addition, having the connection insert positioned within the inserting end helps protect the connection insert. Therefore, and in comparison to some existing designs, the connection insert is afforded with greater protection and the entire jack tool may be provided with greater life of use.

In certain other instances, the jack tool may include a first shaft with an inserting end and a second shaft with a receiving end. The inserting end further includes a resilient body and first and second protrusions positioned on the resilient body. To connect or engage the first shaft with the second shaft, the inserting end of the first shaft is inserted into the receiving end of the second shaft. The receiving end includes a second aperture configured to receive the second protrusion, such as the second aperture referenced herein elsewhere. The second protrusion on the resilient body moves along and touches an interior surface of the receiving end and eventually gets received through the second aperture, such that the first shaft is then connected to the second shaft. To disconnect or disengage the first shaft from the second shaft, the first protrusion is pressed down such that the second protrusion may accordingly be released from the second aperture to effectuate the disconnection of the first shaft from the second shaft. The jack tool effectuates the engagement or connection between the first and second shafts via insertion of the inserting end into the receiving end, and effectuates the disengagement or disconnection via the pressing down of the first protrusion. Therefore the operation is relatively more simplified, and the operation and disassembly can be performed with relatively greater speed.

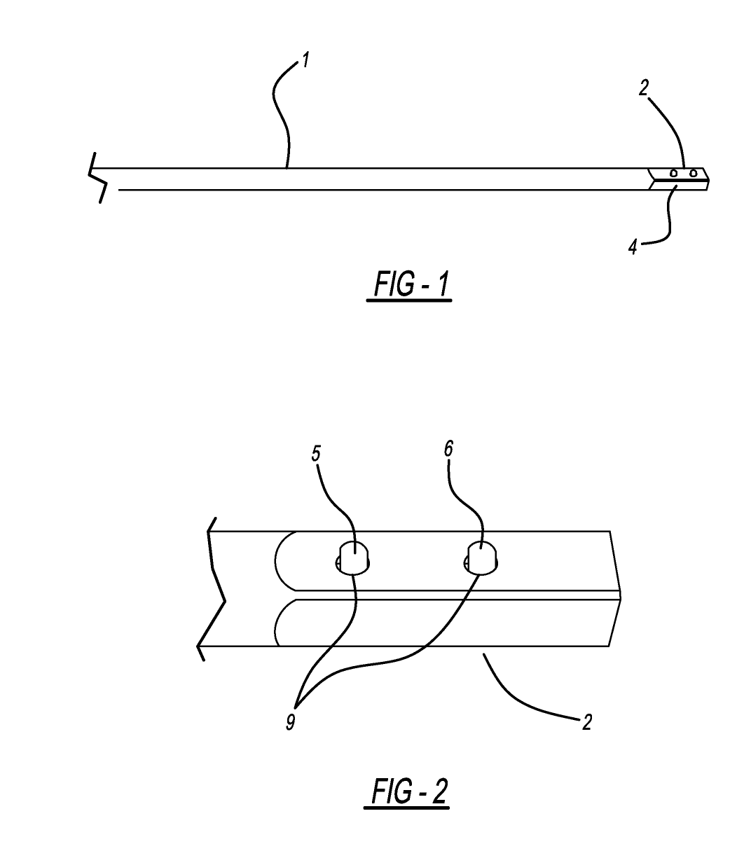

In one or more embodiments, and as depicted in FIG. 1 and FIG. 2 in view of FIG. 6, a jack tool 13 includes a shaft 1 with an inserting end 2, the inserting end 2 may in turn include a connection insert 4 receivable through the inserting end 2 and including first and second protrusions 5, 6. As will be described in more details herein elsewhere, the connection insert 4 may be a built-in component permanently connected to the inserting end 2 or may be a separate component detachable from the inserting end 2.

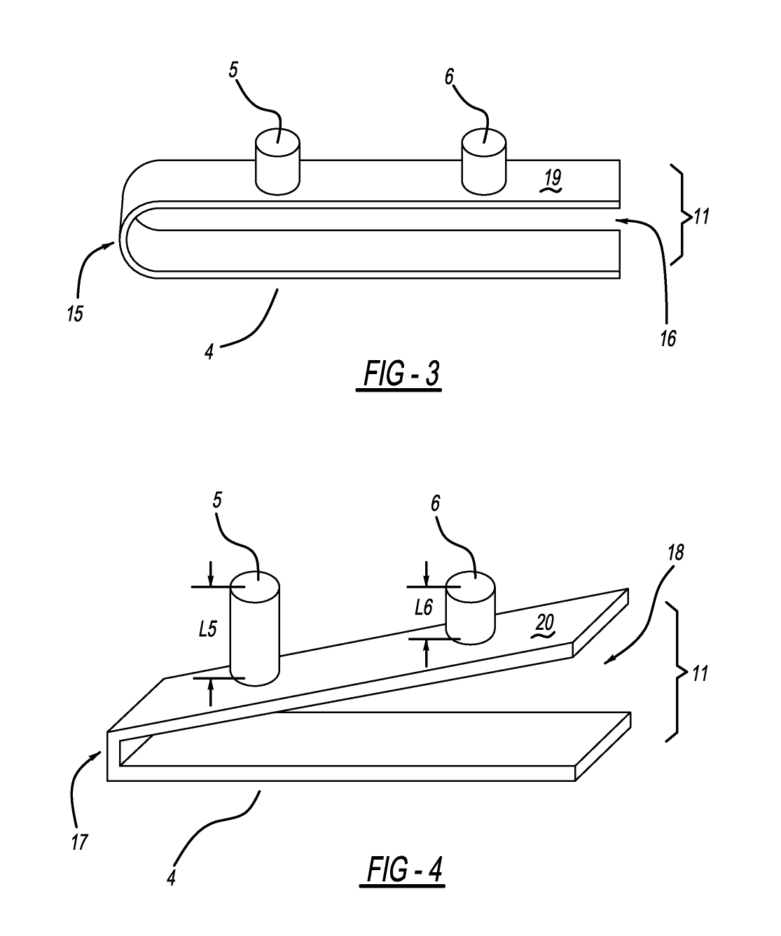

Referring to FIG. 2 in view of FIG. 3 and/or FIG. 4, the first protrusion 5 and the second protrusion 6 may be positioned on a wall such as wall 19 or wall 20 of the connection insert 4, wherein the wall moves upon a compression of the first protrusion 5, which in turn causes the second protrusion 6 to move along with the wall, such that the first protrusion 5 and the second protrusion 6 move along with each other. Moreover, the second protrusion 6 functions as a connector such that when the shaft 1 is to be connected to a matching shaft as needed, all that is needed to do may be to position the second protrusion 6 through an aperture of the matching shaft to effect the connection between the shaft 1 and the matching shaft. In other words, engagement and disengagement between shafts of the jack tool may be realized via controlling the first protrusion and the second protrusion. Therefore, reasonably greater ease of operation is afforded with the jack tool described herein.

Referring back to FIG. 2, the inserting end 2 may include a pair of spaced apart apertures 9 to respectfully receive the first protrusion 5 and the second protrusion 6. The connection insert 4 may be received through the inserting end 2, such that the user may press down the first protrusion 5 and/or the second protrusion 6 from outside of the inserting end 2. Because the connection insert 4 is positioned within and/or through the inserting end 2, the connection insert 4 is relatively better protected.

Referring further to FIG. 3, the connection insert 4 includes a resilient body 11 supporting the first protrusion 5 and the second protrusion 6. The first and second protrusions 5, 6 may be attached to the resilient body 11 after the latter is formed, or alternatively, may be built as integral of the resilient body 11. Accordingly, the first and second protrusions 5, 6 may be of a same or a different material in comparison to the resilient body 11.

In certain instances, and as illustratively depicted in FIG. 3, the resilient body 11 may be configured as a U-shaped resilient piece with an open end 16 facing outwardly, meaning the open end 16 may face an incoming shaft to be connected to the inserting end 2.

In certain other instances, and as illustratively depicted in FIG. 4, the resilient body 11 may be configured as a V-shaped resilient piece with an open end 18 thereof facing outwardly, meaning the open end 18 may face an incoming shaft to be connected to the inserting end 2. The resilient body 11 may include a close end 17 about which the wall 20 may pivot, whereby the first and second protrusions 5, 6 may move along together.

In addition, the first protrusion 5 and the second protrusion 6 both may extend outwardly from a wall of the resilient body 11, such as wall 19 or the wall 20, such that the first protrusion 5 and the second protrusion 6 may be received through a pair of spaced apart apertures 9 of the inserting end 2. In this arrangement, the first protrusion 5 may be pressed from outside of the shaft 1 and the pressing of the first protrusion 5 in turn causes the second protrusion 6 to be connected with the matching shaft such as a second shaft 12 referenced in FIG. 6 and detailed herein elsewhere.

In certain instances, and as illustratively depicted in FIG. 4, when the resilient body 11 is a V-shaped resilient piece, the first protrusion 5 may be presented with a longitudinal length “L5” that is greater in value than a longitudinal length “L6” of the second protrusion 6 to help assist the pressing.

The resilient body 11 may take any suitable cross-sectional shape other than the U-shape or the V-shaped as described herein elsewhere.

Referring back to FIG. 3, the first protrusion 5 may be positioned closer to a close end 15 of the resilient body 11 than the second protrusion 6. A press on the first protrusion 5 causes the wall 19 of the resilient body 11 to pivot about the close end 15. Because the second protrusion 6 is positioned further away from the close end 15 in comparison to the first protrusion 5, a radial distance traveled by the first protrusion 5 is smaller than a radial distance traveled by the second protrusion 6. When the shaft 1 is to be disengaged from a matching shaft as needed, the radial distance traveled by the first protrusion 5 is smaller than the radial distance traveled by the second protrusion 6. A press on the first protrusion 5 beneficially effects the disengagement of the second protrusion 6 from a second aperture 10 referenced in FIG. 6. In other words, pressing the first protrusion 5 which causes it to travel for a certain distance can effectuate the second protrusion 6 to be disengaged completely from the second aperture 10 of the matching shaft such as the second shaft 12. This makes disengagement of the shaft 1 from the matching shaft relatively more convenient and labor-efficient. Similarly, same movement mechanism provided for and/or by the first and second protrusions 5, 6 applies to the designs when the resilient body 11 is configured as a V-shaped resilient piece.

In certain other instances, and as illustratively depicted in FIG. 6, jack tool 13 includes a first shaft 1 with an inserting end 2 and a second shaft 12 with a receiving end 3. The inserting end 2 is shown to have the first and second protrusions 5, 6 of the connection insert 4 extending out and away from an outer surface 21 of the inserting end 2. In particular, the first and second protrusions 5, 6 are positioned on the same wall of the connection insert 4 such as the wall 19 or the wall 20, wherein when the first protrusion 5 is pressed upon, the wall 19 or the wall 20 moves along accordingly. In this arrangement, the second protrusion 6 also moves along accordingly such that a moving-along between the first and second protrusions 5, 6 is realized.

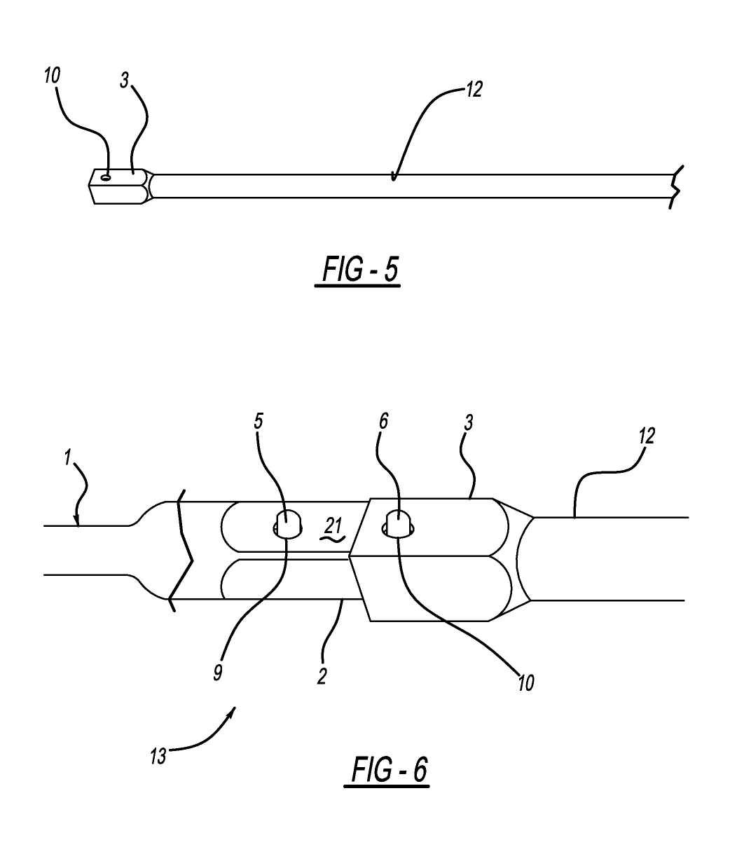

Referring back to FIG. 2 to FIG. 6, the inserting end 2 includes a pair of spaced apart first apertures 9, the first and second protrusions 5, 6 received within the first apertures 9, respectively. The resilient body 11 may be the U-shaped resilient piece with the first and second protrusions 5, 6 positioned on the same wall 19 of the U-shaped resilient piece, such that the first and second protrusions 5, 6 extend away from the same outer surface 21 of the inserting end 2. Accordingly the first and second protrusions 5, 6 may be operated on from outside of the inserting end 2. In this arrangement, the connection insert 4 is positioned inside of the inserting end 2 to provide greater protection to the connection insert 4. Moreover, the U-shaped resilient piece may be positioned within the inserting end 2 with an open end 16 facing outwardly, such that the open end of the U-shaped resilient piece is directed outside of the shaft 1.

As mentioned elsewhere in relation to FIG. 6, the receiving end 3 of the second shaft 12 includes the second aperture 10. The inserting end 2 is sized to be receivable within the receiving end 3, such that the inserting end 2 of the first shaft 1 may be received within the receiving end 3 of the second shaft 12. The inserting end 2 is received within the receiving end 3 when the inserting end 2 and the receiving end 3 are connected to each other. The second protrusion 6 may be received through the second aperture 10, with the first protrusion 5 positioned outside of the receiving end 3. Accordingly, the second protrusion 6 functions as a connector connecting the first shaft 1 and the second shaft 12. The first protrusion is positioned outside of and does not touch the receiving end 3.

Referring back to FIG. 6, to connect the first shaft 1 and the second shaft 12, the inserting end 2 of the first shaft 1 is inserted into the receiving end 3 of the second shaft 12. Because the second protrusion 6 moves along and touches an inner surface (not shown) of the receiving end 3, the inner surface imparts pressure onto the second protrusion 6. Accordingly, the resilient body 11 is compressed and a reset force is created in the direction of protrusion to act upon the second protrusion 6. When the second protrusion 6 moves to the second aperture 10 of the receiving end 3, the pressure imparted by the inner surface of the receiving end 3 onto the second protrusion 6 is removed. The second protrusion 6 travels through the second aperture 10 in response to the reset force. Accordingly the first shaft is connected to the second shaft 12.

When disengaging the first shaft 1 and the second shaft 12, or separating the inserting end 2 of the second shaft 12 away from the receiving end 3 of the first shaft 1, the user may press the first protrusion 5. The press on the first protrusion 5 causes the second protrusion 6 to move through the second aperture 10 inwardly towards an interior of the receiving end 3. When the inward movement of the second protrusion 6 is completed, the second protrusion 6 is disengaged from the second aperture 10, such that the second shaft 12 may then be pulled away and be separate from the first shaft 1.

In other words, to connect the first shaft 1 with the second shaft 12, the inserting end 2 of the first shaft 1 is inserted into the receiving end 3 of the second shaft 12. The receiving end 3 includes an aperture configured to receive the second protrusion 6, such as the second aperture 10 referenced herein elsewhere. The second protrusion 6 on the resilient body 11 moves along the inner surface of the receiving end 3 until the second protrusion 6 is received through the second aperture 10, such that the first shaft and the second shaft 12 may be connected to each other tightly. When the first shaft needs to be disconnected from the second shaft 12, the first protrusion 5 of the first shaft may be pressed upon, which in turn releases the second protrusion 6 from the second aperture 10, and the first shaft is accordingly pulled out and released. For this jack tool 13, connection between the first shaft and the second shaft 12 may be realized via inserting the inserting end to the receiving end 3. The first shaft may be separated from the second shaft 12 via pressing on the first protrusion 5. Therefore the connection and disconnection can be realized relatively faster and more easily.

The shaft 1 may include both the inserting end 2 and the receiving end 3, and the second shaft 12 may also include both the inserting end 2 and the receiving end 3, such that multiple shafts including the first shaft 1 and/or the second shaft 12 may be connected to one another.

In one or more embodiments, the disclosed invention as set forth herein overcomes the challenges faced by known production of a jack tool and/or a jack assembly. However, one skilled in the art will readily recognize from such discussion, and from the accompanying drawings and claims that various changes, modifications and variations can be made therein without departing from the true spirit and fair scope of the invention as defined by the following claims.

What is claimed is:

1. A jack tool comprising:
an inserting end, the inserting end including a connection insert positioned within the inserting end, the connection insert including first and second protrusions linked to be movable together.

2. The jack tool of claim 1, wherein the inserting end includes a pair of spaced apart first apertures to receive the first and second protrusions, respectively.

3. The jack tool of claim 1, wherein the connection insert includes a resilient body, the first and second protrusions being positioned upon the resilient body.

4. The jack tool of claim 3, wherein the resilient body is a U-shaped resilient piece.

5. The jack tool of claim 4, wherein the U-shaped resilient piece is positioned within the inserting end with an open end facing outwardly.

6. The jack tool of claim 3, wherein the resilient body is a V-shaped resilient piece positioned within the inserting end with an open end facing outwardly.

7. The jack tool of claim 3, wherein the first and second protrusions extend outwardly from a wall of the resilient body.

8. The jack tool of claim 6, wherein the first and second protrusions extend outwardly from a wall of the resilient body, wherein the first protrusion has a longitudinal length greater than a longitudinal length of the second protrusion.

9. A jack tool comprising
a first shaft with an inserting end; and
a second shaft with a receiving end, wherein the inserting end includes a connection insert, the connection insert including a resilient body with first and second protrusions positioned on the resilient body.

10. The jack tool of claim 9, wherein the resilient body is a U-shaped resilient piece.

11. The jack tool of claim 10, wherein the first and second protrusions positioned on the U-shaped resilient piece.

12. The jack tool of claim 11, wherein the U-shaped resilient piece is positioned within the inserting end with an open end facing outwardly.

13. The jack tool of claim 9, wherein the inserting end includes a pair of spaced apart first apertures to receive the first and second protrusions, respectively.

14. The jack tool of claim 13, wherein the receiving end includes a second aperture.

15. The jack tool of claim 14, wherein the inserting end is sized to be receivable within the receiving end.

16. The jack tool of claim 15, wherein the second protrusion is positioned through the second aperture when the inserting end is connected to the receiving end.

17. The jack tool of claim 16, wherein the first protrusion is positioned outside of the receiving end.

18. A jack tool comprising:
a first shaft including an inserting end with two spaced part first apertures;
a second shaft including a receiving end with a second aperture; and
a connection insert including first and second protrusions, the first protrusion receivable through one of the first apertures, the second protrusion receivable through both the second aperture and the other of the first apertures.

19. The jack tool of claim 18, wherein the connection insert further includes a resilient body to support the first and second protrusions.

20. The jack tool of claim 18, wherein the connection insert is detachable from the inserting end of the first shaft.
